(19) United States
(12) Patent Application Publication
(10) Pub. No.: US 2013/0209293 A1
(43) Pub. Date: Aug. 15, 2013

(54) CEILING FAN MOTOR AND CEILING FAN

(71) Applicant: Nidec Corporation, (US)

(72) Inventors: Yosuke KAWANO, Kyoto (JP); Yusuke IWAI, Kyoto (JP); Masahiro YAMADA, Kyoto (JP); Hitoshi TAKAKI, Kyoto (JP)

(73) Assignee: NIDEC CORPORATION, Kyoto (JP)

(21) Appl. No.: 13/761,230

(22) Filed: Feb. 7, 2013

(30) Foreign Application Priority Data
Feb. 15, 2012 (JP) 2012-031139
Oct. 19, 2012 (JP) 2012-231418

(51) Int. Cl. F04D 25/06; H02K 7/08

(52) U.S. Cl. CPC F04D 25/06; H02K 7/08
USPC 417/423.7; 310/90

(57) ABSTRACT

A ceiling fan motor includes a stationary unit, a rotary unit, and a bearing unit, wherein the stationary unit includes a shaft arranged along a center axis extending in an up-down direction, and an armature directly or indirectly fixed to the shaft. The rotary unit includes a rotor holder arranged to cover the armature from above and below, the rotor holder including an upper rotor holder member and a lower rotor holder member, and a rotor annularly arranged on an inner circumferential surface of the rotor holder in a radially opposing relationship with the armature. The bearing unit rotatably supports the rotor holder with respect to the armature, and includes an upper bearing member arranged between the shaft and the rotor holder at an axial upper side of the armature, and a lower bearing member arranged between the shaft and the rotor holder at a lower side of the armature.

### BACKGROUND OF THE INVENTION

1. Field of the Invention

The present invention relates to a motor, and more specifically to a motor preferably for use in a ceiling fan suspended from a ceiling and a ceiling fan including the motor. More particularly, the present invention pertains to a structure by which an impeller is fixed to a rotor unit of a motor.

2. Description of the Related Art

As disclosed in FIG. 2 of Japanese Patent Application Publication No. 2008-297939, blades (referred to as “fan 12” in Japanese Patent Application Publication No. 2008-297939) are directly attached to a DC motor in a conventional ceiling fan. In this case, the respective blades need to be removed during maintenance of the DC motor, which poses a problem in terms of workability.

In view of this, Japanese Patent Application Publication No. H11-210676 discloses a method for improving workability when installing an impeller. In this method, blades are attached to a blade support portion (boss) in advance. Then, the blade support portion is fastened to a rotor holder (outer rotating body) by tightening a fastener nut to an external thread formed in the rotor holder.

In the method disclosed in Japanese Patent Application Publication No. H11-210676, however, the blade support portion (boss) is positioned near a rotation center axis. For example, if an external load is applied to the blade support portion (boss) or the blades, moment loads are concentrated on a fixing portion. Thus, the rotor holder (outer rotating body) or the blade support portion (boss) may possibly be broken. In a typical ceiling fan, the outer diameter of the blades is several times as large as the outer diameter of a DC motor. Consequently, the moment loads applied to the fixing portion by the external load tend to become larger.

### SUMMARY OF THE INVENTION

A fan motor in accordance with a preferred embodiment of the present invention includes a stationary unit; a rotary unit; and a bearing unit, the stationary unit including a shaft arranged along a center axis extending in an up-down direction and an armature directly or indirectly fixed to the shaft; the rotary unit including a rotor holder arranged to cover the armature from above and below, the rotor holder including an upper rotor holder member and a lower rotor holder member and a rotor annularly arranged on an inner circumferential surface of the rotor holder in a radially opposing relationship with the armature, the bearing unit including an upper bearing member configured to rotatably support the rotor holder with respect to the armature and arranged between the shaft and the rotor holder at an axial upper side of the armature and a lower bearing member arranged between the shaft and the rotor holder at an axial lower side of the armature, wherein the rotor holder includes an attachment portion arranged radially outward of the bearing unit so that an impeller of a ceiling fan can be attached to the attachment portion.

The ceiling fan includes the motor described above; a substantially cup-shaped blade support portion opened axially upward and fixed to the rotor holder; and an impeller including a plurality of blades extending radially outward from the blade support portion.

With the preferred embodiments of the present invention, it is possible to easily attach the impeller to the rotor holder and to minimize damage of the attaching portion or the impeller even when an external load is applied thereto.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical sectional view taken along a plane containing a center axis J1 in a motor 1 according to a first preferred embodiment of the present invention.

FIG. 2 is a perspective view of the motor for use in a ceiling fan according to the first preferred embodiment of the present invention, which is obliquely seen from above.

FIG. 3 is a vertical sectional view taken along a plane containing a center axis J1 in the ceiling fan according to the first preferred embodiment of the present invention.

FIG. 4 is a vertical sectional view taken along a plane containing a center axis J1 in a ceiling fan according to a second preferred embodiment of the present invention.

FIG. 5 is a vertical sectional view taken along a plane containing a center axis J1 in a ceiling fan according to a third preferred embodiment of the present invention.

FIG. 6 is a vertical sectional view taken along a plane containing a center axis J1 in a ceiling fan according to a fourth preferred embodiment of the present invention.

FIG. 7 is a perspective view of an upper cover of the ceiling fan according to the fourth preferred embodiment of the present invention, which is obliquely seen from above.

### DETAILED DESCRIPTION OF THE PREFERRED EMBODIMENTS

In the following description, the upper side along a center axis J1 of a motor 1 will be just referred to as “upper”. The lower side along the center axis J1 of the motor 1 will be just referred to as “lower”. In other words, the center axis J1 extends in an up-down direction. The direction parallel or substantially parallel to the center axis J1 will be just referred to as “axial direction”. The radial direction about the center axis J1 will be just referred to as “radial direction”. The circumferential direction about the center axis J1 will be just referred to as “circumferential direction”.

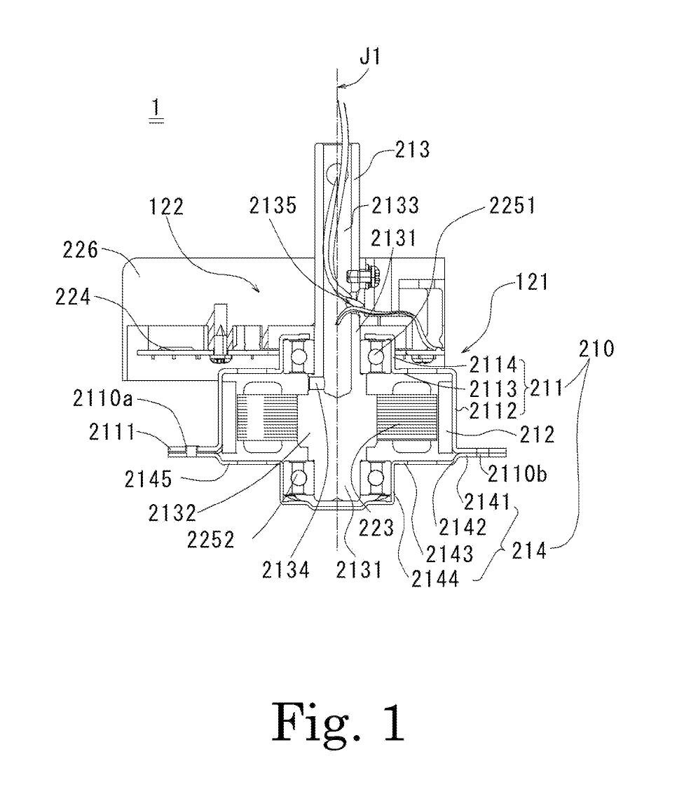

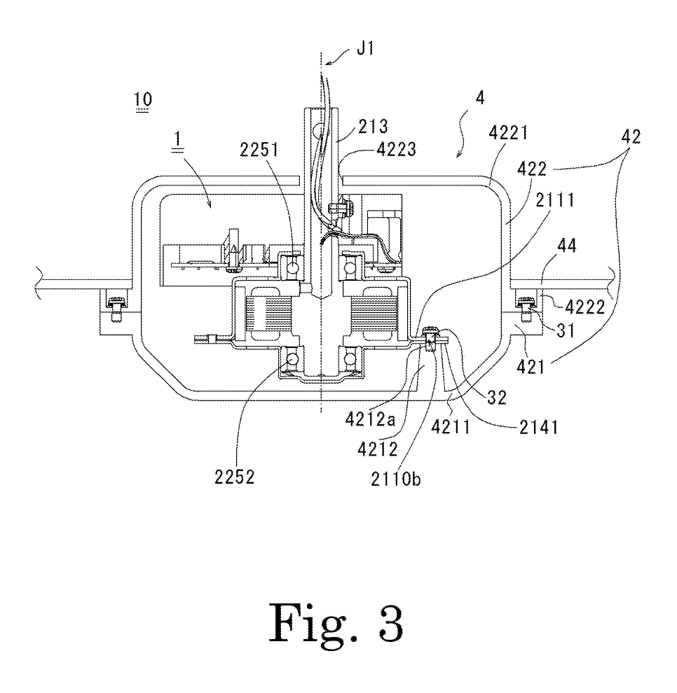

Description will now be provided with respect to a first preferred embodiment of the present invention. FIG. 1 is a vertical sectional view taken along a plane containing a center axis J1 in a motor 1 according to a first preferred embodiment. The motor 1 is preferably a so-called DC motor to which an impeller is not attached. As shown in FIG. 3, for example, a ceiling fan 10 is preferably fabricated by attaching an impeller 4 to the motor 1 from below.

The motor 1 preferably includes a rotary unit 121 as a rotating body and a stationary unit 122 as a fixed body. The rotary unit 121 preferably includes a rotor holder 210 and a rotor 212. The rotor holder 210 is a magnetic body and preferably includes an upper rotor holder member 211 and a lower rotor holder member 214. The rotor 212 preferably has a cylindrical or substantially cylindrical shape and is fixed to the inner circumferential surface of the upper rotor holder member 211. In the first preferred embodiment, the rotor 212 is preferably a cylindrical or substantially cylindrical magnet. However, the shape of the rotor 212 is not limited to the cylindrical or substantially cylindrical shape. Alternatively, a plurality of arc-shaped magnets may be annularly arranged on the inner circumferential surface of the upper rotor holder member 211. The rotor 212 may be fixed to the inner circumferential surface of the lower rotor holder member 214. The upper rotor holder member 211 preferably includes an upper flange 2111 provided in the lower end portion thereof to extend radially outward from a cylinder portion. The lower rotor holder member 214 preferably includes a lower flange 2141 arranged in the upper end portion thereof to extend radially outward from a cylinder portion. The lower surface of the upper flange 2111 and the upper surface of the lower flange 2141 are preferably joined together by, for example, a caulked burring portion 2110a in a state that they are axially brought into contact with each other. In other words, the rotor holder 210 preferably includes a flange protruding radially outward. The joining of the upper flange 2111 and the lower flange 2141 together is not limited to the use of a caulked burring portion 2110a but may alternatively be performed by, for example, a fastener such as a screw, an adhesive agent, welding, caulking, etc. The burring caulking member 2110a will now be described in detail. A cylindrical or substantially cylindrical burring portion extends upward from the lower flange 2141. The burring portion protrudes upward through a through-hole formed in the upper flange 2141. The protruding section of the burring portion is enlarged radially outward by plastic deformation so as to fix the upper flange 2111 and the lower flange 2141 together.

The stationary unit 122 preferably includes a shaft 213, an armature 223, a circuit board 224, and a board case 226. The shaft 213 is arranged along the center axis J1 extending in the up-down direction. The shaft 213 preferably includes a large-diameter portion 2132 having a large outer diameter and a small-diameter portion 2131 having a small outer diameter. The armature 223 is directly fixed to the outer circumferential surface of the large-diameter portion 2132 in a state that the armature 223 is radially opposed to the rotor 212. The armature 223 may be indirectly fixed to the shaft 213 through another member. The armature 223 is covered by the upper rotor holder member 211 and the lower rotor holder member 214 from above and below.

The small-diameter portion 2131 of the shaft 213 is arranged above and below the large-diameter portion 2132. In other words, the small-diameter portion 2131 is arranged at the axial upper and lower sides of the large-diameter portion 2132. An upper bearing member 2251 is arranged on the upper extension of the small-diameter portion 2131. A lower bearing member 2252 is arranged on the lower extension of the small-diameter portion 2131. In other words, the upper bearing member 2251 and the lower bearing member 2252 are arranged at the axial upper and lower sides of the armature 223.

The upper rotor holder member 211 preferably includes a large inner diameter portion 2112 to which the rotor 212 is fixed and a disc portion 2113 extending radially inward from the upper end of the large inner diameter portion 2112. The upper rotor holder member 211 preferably further includes a small inner diameter portion 2114 extending axially upward from the inner end of the disc portion 2113. The outer circumferential surface of the upper bearing member 2251 is fixed to the inner circumferential surface of the small inner diameter portion 2114.

The lower rotor holder member 214 preferably includes a slant surface 2142 inclined radially inward and downward from the inner end of the lower flange 2141 and a disc portion 2143 extending radially inward from the lower end of the slant surface 2142. The lower rotor holder member 214 preferably further includes a small inner diameter portion 2144 extending axially downward from the inner end of the disc portion 2143. The outer circumferential surface of the lower bearing member 2252 is fixed to the inner circumferential surface of the small inner diameter portion 2144.

Since a bearing unit including the upper bearing member 2251 and the lower bearing member 2252 is arranged between the shaft 213 and the rotor holder 210, the rotor holder 210 is rotatably supported with respect to the armature 223. In the present preferred embodiment, the upper bearing member 2251 and the lower bearing member 2252 are preferably provided by ball bearings. Alternatively, it is possible to use slide bearings or any other desirable type other bearings.

The armature 223 is positioned radially inward of the rotor 212. The shaft 213 includes a hole 2133 arranged above the armature 223 to extend axially upward along the center axis J1. The shaft 213 includes a lower transverse hole 2134 provided below the upper bearing member 2251 so as to interconnect the hole 2133 and the inside of the rotor holder 210. The shaft 213 includes an upper transverse hole 2135 provided above the upper bearing member 2251 so as to interconnect the hole 2133 and the outside of the rotor holder 210. In the present preferred embodiment, the hole 2133, the lower transverse hole 2134 and the upper transverse hole 2135 are holes. As a modified example of the present preferred embodiment, it may be possible to use grooves. In other words, the shaft 213 includes a guide groove or a guide hole which guides lead wires extended from the armature 223 toward the axially upper portion higher than the upper rotor holder member 211.

The board case 226 is preferably fixed to the shaft 213 in the vicinity of the upper transverse hole 2135. The circuit board 224 includes, for example, electronic components and circuit patterns defining a drive control circuit of the motor and is fixed to the board case 226. The armature 223 includes a plurality of coils preferably defined by, for example, winding conductive wires. Lead wires which are terminals of the coils are led out from the inside of the rotor holder 210 to the outside thereof through the lower transverse hole 2134, the hole 2133 and the upper transverse hole 2135. The lead wires are soldered and electrically connected to circuit board 224. Electrically conductive wires are soldered and electrically connected to the circuit board 224. The electrically conductive wires are guided toward the upper side of the shaft 213 through the upper transverse hole 2135 and the hole 2133 and are preferably connected to, for example, a power supply. Consequently, the lead wires are electrically connected at the vicinity of the small-diameter portion of the circuit board 224.

The electric power is controlled from the power supply to a drive control circuit through the electrically conductive wires such that an electric current is fed to the coils. As a consequence, magnetic fluxes are generated on the radial outer circumferential surface of the armature 223. Due to the magnetic interaction between the fluxes of the armature 223 and the rotor 212, torque acting about the center axis J1 is generated between the armature 223 and the rotor 212.

In order to efficiently produce the torque using the magnetic interaction between the armature 223 and the rotor 212, it is preferred that the magnetic fluxes generated from the rotor 212 pass through the coils wound around the armature 223 as far as possible. To this end, it is preferred that the magnetic fluxes leaked from the rotor 212 be kept smallest. In the present preferred embodiment, the lower end of the rotor 212 fixed to the upper rotor holder member 211 is positioned axially near the joint surface of the upper flange 2111 and the lower flange 2141. The lower rotor holder member 214 includes a lower region portion 2145. The lower region portion 2145 is positioned axially below the rotor 212. In other words, a gap is defined between the lower region portion 2145 and the lower end surface of the rotor 212. Since, in the lower region portion 2145, air present in a side lower than the upper surface of the lower flange 2141 is larger in magnetic resistance than a magnetic body, the magnetic fluxes generated from the rotor 212 are barely leaked to the disc portion 2143.

Through-holes axially passing through the upper flange 2111 and the lower flange 2141 are defined in the upper flange 2111 and the lower flange 2141. These through-holes serve as an attachment portion 2110b arranged to be fixed to an impeller 4 (to be described later). In other words, the attachment portion is arranged on the flange. Considering the shape of the upper rotor holder member 211 and the lower rotor holder member 214, the upper flange 2111 and the lower flange 2141 are positioned lower than the axial center of the rotor holder 210. In other words, the upper flange 2111 and the lower flange 2141 are positioned lower than the center of the dimension between the upper bearing member 2251 and the lower bearing member 2252. In other words, the upper flange 2111 and the lower flange 2141 are positioned lower than the axial center of the rotor 212. Accordingly, the attachment portion 2110b arranged to support an impeller 4 is positioned lower than the center of the dimension between the upper bearing member 2251 and the lower bearing member 2252 and lower than the axial center of the rotor 212. This makes it possible to support the impeller 4 in a low position. It is therefore possible to reduce the radial displacement of the gravity center of the rotating body and to reduce the vibration of the rotating body during high-speed rotation.

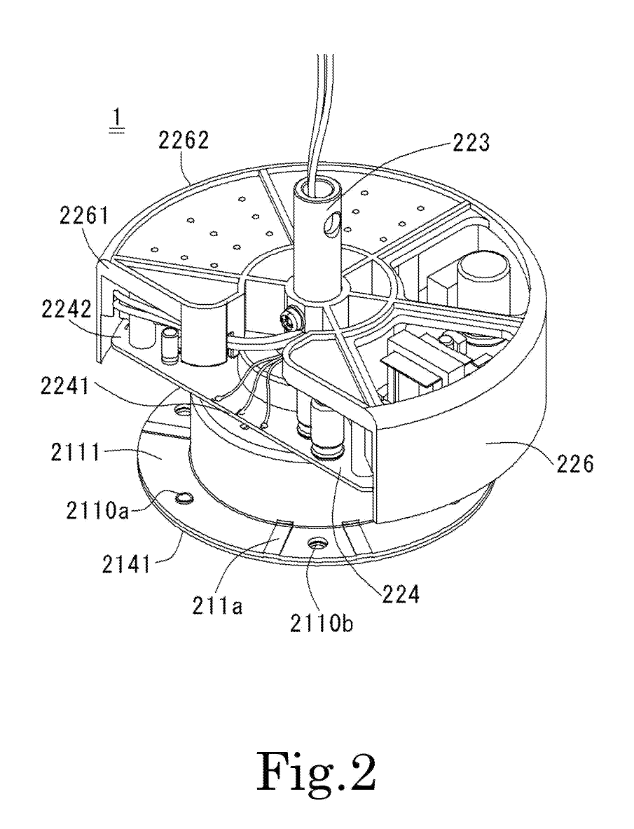

FIG. 2 is a perspective view of the motor according to the first preferred embodiment, which is obliquely seen from above. Each of the upper flange 2111 and the lower flange 2141 preferably includes a plurality of caulked burring portions 2110a (only one of the caulked burring portions 2110a is shown in FIG. 2 due to the existence of the circuit board 224 and the board case 226). More specifically, the caulked burring portions 2110a are preferably arranged at three points equally spaced apart along the circumferential direction, for example. The attachment portions 2110b are also preferably arranged at three points at an equal interval with respect to the caulked burring portions 2110a, for example.

The upper flange 2111 preferably includes a plurality of ribs 211a protruding axially upward. More specifically, a pair of ribs 211a protruding axially upward is arranged at the circumferential opposite sides of each of the attachment portions 2110a in the circumferentially spaced-apart positions. The ribs 211a are arranged in the circumferential positions nearer to the attachment portions 2110b than the caulked burring portions 2110a. The ribs 211a are preferably formed by, for example, half-blanking. The ribs 211a radially extend from the upper rotor holder member 211 toward the radial outer end of the upper flange 2111. As a result, the radial cross-sectional secondary moment of the upper flange 2111 is increased and the rigidity thereof is increased. In other words, even if an external load is applied to the impeller 4 after the impeller 4 is attached to the attachment portions 2110b, deformation will not be or will only barely be generated in the upper flange 2111 and the lower flange 2141.

The ribs 211a may be defined in the lower flange 2141. Insofar as the ribs 211a have a shape capable of increasing the cross-sectional secondary moment of the upper flange 2111 and the lower flange 2141, no restriction is imposed on the member on which the ribs 211a are provided and the position in which the ribs 211a are arranged. In other words, the flange includes a plurality of ribs protruding in at least one of the axial upper and lower directions. Additionally, it should be noted that it is also possible to form the ribs 211a by a processing method other than the half-blanking.

As shown in FIG. 2, the board case 226 and the circuit board 224 preferably include small-diameter portions 2241 and 2261 positioned radially inward of the attachment portions 2110b when seen in the axial direction and large-diameter portions 2242 and 2262 positioned radially outward of the attachment portions 2110b when seen in the axial direction.

Description will now be made of the shape of the circuit board 224. The circuit board 224 preferably includes a board small-diameter portion 2241 defined by a linearly cut away portion and a board large-diameter portion 2242 which does not include a cut away portion. In this case, the attachment portion 2110b positioned radially outward of the board small-diameter portion 2241 is visible with naked eyes when seen in the axial direction.

Description will now be made on the shape of the board case 226. The board case 226 preferably includes a case small-diameter portion 2261 defined by a linearly cut away portion and a case large-diameter portion 2262 which does not include a cut away portion. In this case, the attachment portion 2110b positioned radially outward of the case small-diameter portion 2261 is visible with naked eyes when seen in the axial direction. This makes it easy to perform a work of attaching a fastener, such as, for example, a screw 32 to the attachment portion 2110a from above.

The board case 226 surrounds the circuit board 224 from the axial upper side and the radial outer side so as to prevent the electronic components mounted on the circuit board 224 from being damaged by an external impact. The board case 226 is opened so that the board small-diameter portion 2241 can be exposed at the side of the case small-diameter portion 2261. Accordingly, the land portion, to which the lead wires are soldered, is exposed to the outside. This makes it easy to perform a soldering work. The land portion is preferably provided near the board small-diameter portion 2261. More specifically, the land portion is arranged around the smallest-diameter portion of the board small-diameter portion 2261.

FIG. 3 is a vertical sectional view taken along a plane containing the center axis J1 in a ceiling fan 10 according to a first preferred embodiment. A ceiling fan 10 is defined by attaching the impeller 4 to the motor 1. The impeller 4 preferably includes a blade support portion 42 and a plurality of blades 44. The blade support portion 42 preferably includes a lower blade support section 421 and an upper blade support section 422.

The lower blade support section 421 preferably includes a substantially cup-shaped lower body 4211 opened upward and a motor support pedestal 4212 protruding axially upward from the bottom of the lower body 4211. The motor support pedestal 4212 has thread holes 4212a extending downward from the upper surface thereof. The thread holes 4212a are preferably arranged at three points equally spaced apart in the circumferential direction, for example. The upper surface of the motor support pedestal 4212 makes contact with the lower surface of the lower flange 2141 at the axial lower side. Screws 32 are inserted into the thread holes 4212a through the attachment portions 2110b and are tightened to the upper surface of the motor support pedestal 4212. Thus the lower blade support section 421 is attached to the motor 1. With this configuration, the lower blade support section 421 can be brought toward the motor 1 from below and can be attached to the motor 1. By including the small-diameter portions 2241 and 2261, the circuit board 224 and the board case 226 can protrude radially outward beyond the lower flange 2141. This makes it possible to increase the electronic-component mounting area of the circuit board 224.

The upper blade support section 422 preferably includes a substantially cup-shaped upper body 4221 opened downward. A through-hole coaxial with the center axis J1 is provided in the central region of the upper body 4221. The through-hole is a shaft insertion hole 4223 into which the shaft 213 is inserted. The shaft 213 is kept stationary and the upper body 4221 is rotated. In order to prevent the shaft 213 and the upper body 4221 from making contact with each other during rotation of the upper body 4221, the diameter of the shaft insertion hole 4223 is preferably set larger than the outer diameter of the shaft 213.

The upper body 4221 preferably includes a ring-shaped blade support seat 4222 protruding radially outward from the lower end portion of the upper body 4221. The lower surface of the blade support seat 4222 makes contact with the upper surface of the lower body 4211. The blade support seat 4222 preferably includes through-holes extending in the axial direction and the lower body 4211 preferably includes thread holes arranged in a corresponding relationship with the through-holes of the blade support seat 4222. The thread holes of the lower body 4211 extend downward from the upper surface of the lower body 4211. Screws 31 are inserted into the through-holes of the blade support seat 4222 from above and are threadedly coupled to the female threads of the thread holes of the lower body 4211. As a result, the upper body 4221 and the lower body 4211 are fixed to each other.

The blades 44 are preferably attached to the upper body 4221 in advance before the upper body 4221 is fixed to the lower body 4211. Detailed description will now be made on a structure in which the blades 44 are attached to the blade support seat 4222. The radial inner ends of the blades 44 are placed on the upper surface of the blade support seat 4222. The blades 44 are then preferably fixed to the blade support seat 4222 by fasteners, such as, for example, screws. As a result, the blades 44 are fixed to the upper blade support section 422 in a state where the blades 44 extend radially outward from the upper blade support section 422. No particular restriction is imposed on the method of fixing the blades 44. For example, it may be possible to use not only fasteners but also welding, caulking, etc.

Preferably, the impeller 4 is attached to the motor 1 as far outward in the radial direction as possible. In the present preferred embodiment, the impeller 4 is fixed to the upper flange 2111 and the lower flange 2141 of the rotor holder 210. Thus the impeller 4 is fixed to the substantially radially outermost end of the rotor holder 210. When an external load is applied to the blades 44 due to, for example, an earthquake, a strong wind, etc., the load is transferred to the attachment portion 2110b through the upper blade support section 422. In this regard, the load applied to the attachment portion 2110b is decided by the moment which in turn is calculated by multiplying the distance between the load applying point and the attachment portion 422 by the load amount. In other words, the moment load can be reduced by shortening the distance between the load applying point and the attachment portion 422. The attachment portion 2110b is preferably arranged more radially outward than the upper bearing 2251 and the lower bearing 2252. Therefore, even if an external load is transferred to the rotor holder 210, the load will not be or will only be barely transferred to the shaft 213, the upper bearing 2251, and the lower bearing 2252. In a hypothetical case where the load is applied to the upper bearing 2251 and the lower bearing 2252, scratches would be generated in the race surfaces of the ball bearings. These scratches may possibly become a cause of the generation of noises. With the present preferred embodiment, the load is not or is only barely transferred to the upper bearing 2251 and the lower bearing 2252. Accordingly, scratches are substantially not, or are only barely, generated in the race surfaces of the ball bearings.

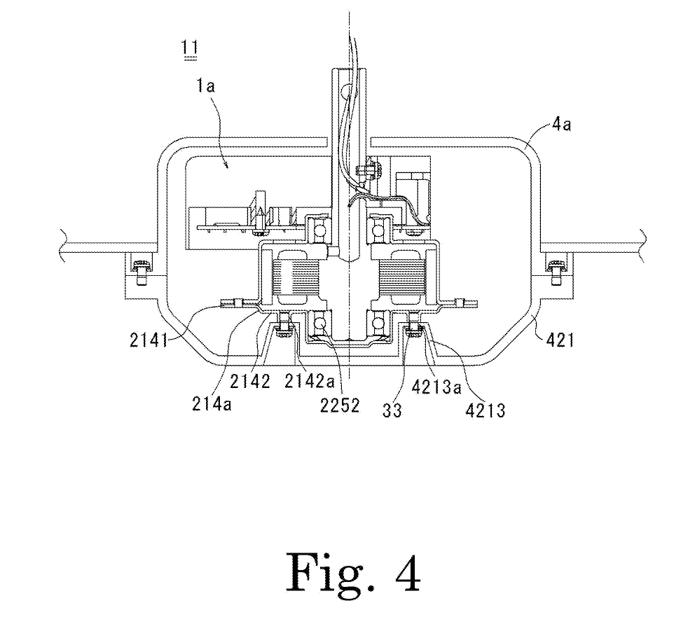

Next, description will be made of a second preferred embodiment of the present invention. FIG. 4 is a vertical sectional view taken along a plane containing the center axis J1 in a ceiling fan 11 according to a second preferred embodiment. The ceiling fan 11 of the second preferred embodiment differs from the ceiling fan of the first preferred embodiment in terms of the position of the attachment portions 2110b. Other points are preferably the same as those of the ceiling fan of the first preferred embodiment. Reference symbols used in FIG. 4 remain the same as those of FIG. 3 except the differing points.

The lower rotor holder member 214a preferably includes a bottom portion 2142 positioned between the lower flange 2141 and the lower bearing member 2252. Lower burring portions 2142a extending in the axial direction and protruding downward are defined in the bottom portion 2142. The lower burring portions 2142a serve as attachment portions to which the impeller 4a is attached. The lower burring portions 2142a are arranged at a plurality of points equally spaced apart in the circumferential direction. In the present preferred embodiment, the number of the lower burring portions 2142a preferably is three, for example. Since the lower burring portions 2142a protrude axially downward, there is no possibility that the lower burring portions 2142a reduce the occupying area of the coils wound around the armature. Accordingly, it is possible to increase the occupying percentage of the coils with respect to the total volume of the ceiling fan 11. This makes it possible to enhance the efficiency of the motor 1a.

The lower body 4211 preferably includes motor support pedestals 4213 protruding axially upward from the lower body 4211 toward the lower burring portions 2142a. Each of the motor support pedestals 4213 sectional view includes a through-hole 4213a extending in the axial direction. The upper extension of the through-hole 4213a includes a diameter large enough to receive a fastener, such as, for example, a screw 33. The lower extension of the through-hole 4213a has a diameter large enough to receive the head of the screw 33. In other words, the screw 33 can be inserted into the through-hole 4213a from below. The upper surfaces of the motor support pedestals 4213 make contact with the lower ends of the lower burring portions 2142a. The screw 33 can be tightened to the female thread provided on the inner circumferential surface of each of the lower burring portions 2142a. As a result, the lower body 4211 is fixed to the lower rotor holder member 214a. With this configuration, the lower blade support section 421 can be brought toward the motor 1 from below and can be attached to the motor 1. Thus the circuit board 224 and the board case 226 can protrude radially outward beyond the lower flange 2141. This makes it possible to increase the electronic-part mounting area of the circuit board 224.

Since the lower burring portions 2142a are positioned more radially outward than the lower bearing member 2252, it is possible to reduce the moment load generated in the lower burring portions 2142a. This makes it possible to significantly reduce and prevent deformation of the lower body 4211 or the lower rotor holder member 214.

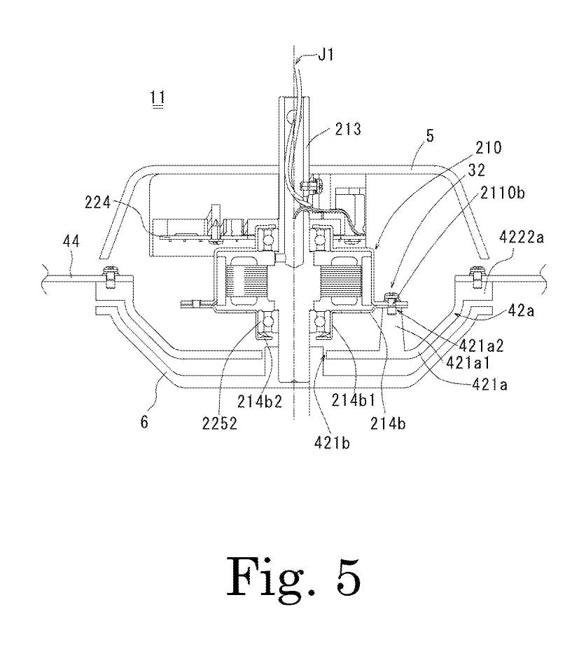

Next, description will be made of a third preferred embodiment. FIG. 5 is a vertical sectional view taken along a plane containing the center axis J1 in a ceiling fan 11 according to a third preferred embodiment. The ceiling fan 11 of the third preferred embodiment differs from the ceiling fan of the first preferred embodiment in terms of the position of the attachment portions 2110b. Other points are the same as those of the ceiling fan of the first preferred embodiment. Reference symbols used in FIG. 5 remain the same as those of FIG. 3 except the differing points.

As in the first preferred embodiment, the lower rotor holder member 214b preferably includes a lower flange 2141. The lower flange 2141 is preferably provided with attachment portions 2110b. The lower rotor holder member 214b further includes a cylinder portion 214b1 protruding axially downward from the radial inner end of the lower rotor holder member 214b. The lower bearing member 2252 is held on the inner circumferential surface of the cylinder portion 214b1. A bearing support portion 214b2 extends radially inward from the lower end of the cylinder portion 214b1. The bearing support portion 214b2 sectional view includes an inner circumferential surface coaxial with the center axis J1. The shaft 213 extends through the bore of the bearing support portion 214b2 and protrudes downward beyond the lower rotor holder member 214b.

The blade support portion 42a preferably includes a substantially cup-shaped body 421a opened upward. The body 421a sectional view includes a through-hole 421b coaxial with the center axis J1. The through-hole 421b is preferably arranged into a cylindrical columnar shape about the center axis J1. The blade support portion 42a preferably includes motor support pedestals 421a1 protruding upward toward the attachment portions 2110b. Each of the motor support pedestals 421a1 preferably includes a thread hole 421a2 extending downward from the upper surface thereof. Screws 32 are preferably inserted into the attachment portions 2110b and the screw holes 421a2 from above and are tightened to the screw holes 421a2. As a result, the blade support portion 42a is fixed to the rotor holder 210. Further, the blade support portion 42a includes a ring-shaped blade support seat 4222a arranged in the radial outer circumference. The blades 44 are preferably fixed to the blade support seat 4222a by screws, for example.

Since the attachment portions 2110b are positioned in the substantially radially outermost end portion of the rotor holder 210, it is possible to reduce the moment load generated in the lower flange 2114 and the upper flange 2111. This makes it possible to significantly reduce and prevent deformation of the body 421a or the lower rotor holder member 214b.

An upper cover 5 is attached to the shaft 213 so that particles such as dust or the like do not at all or substantially do not infiltrate onto the upper surface of the blade support portion 42a. The upper cover 5 has a substantially cup-like shape opened downward. The radial outer end portion of the upper cover 5 covers the upper surface of the blade support seat 4222a. This makes it possible to prevent particles from infiltrating onto the circuit board 224.

A lower cover 6 covering the blade support portion 42a from below is attached to the lower end of the shaft 213. Therefore, only the blades 44 are rotated in the ceiling fan. This makes it possible to improve the decorative appearance of the ceiling fan.

As a modified example, the shaft 213 may have a through-hole extending along the full length thereof. In this case, lead wires can be led out from the axial upper side toward the axial lower side of the shaft 213. This makes it possible to attach a lighting device to the shaft 214 or the lower cover 6 as a non-rotating body.

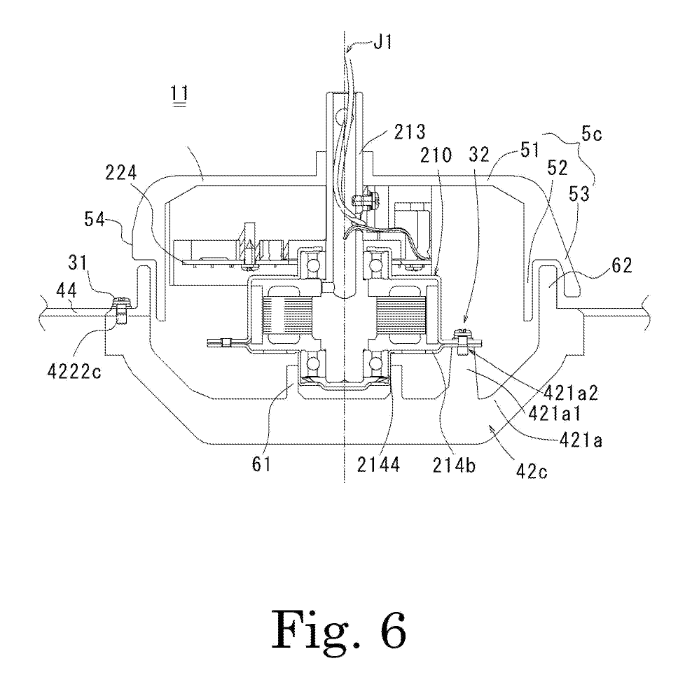

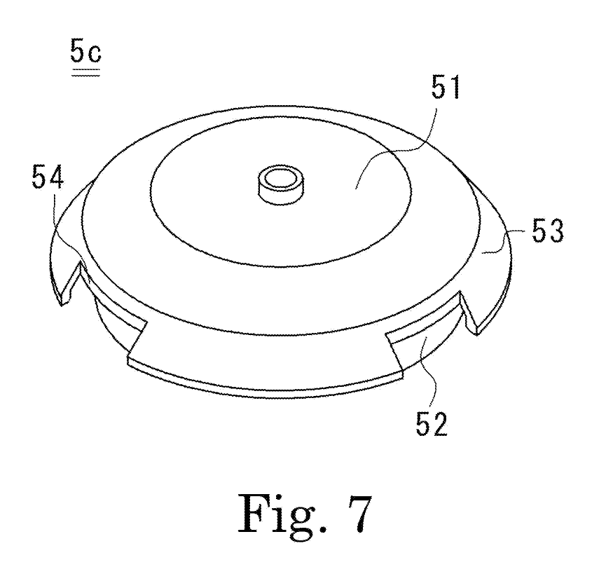

Next, description will be made of a fourth preferred embodiment. FIG. 6 is a vertical sectional view taken along a plane containing the center axis J1 in a ceiling fan 12 according to a fourth preferred embodiment. FIG. 7 is a perspective view of an upper cover 5c of the ceiling fan 11 according to the fourth preferred embodiment, which is obliquely seen from above. The ceiling fan 11 of the fourth preferred embodiment differs from the ceiling fan of the third preferred embodiment in that the lower cover 6 and the blade support portion 42a are preferably defined as a single monolithic member in terms of the shape of the upper cover 5. Other points are the same as those of the ceiling fan of the third preferred embodiment. Reference symbols used in FIG. 6 remain the same as those of FIG. 5 except the differing points. In the fourth preferred embodiment, as shown in FIG. 5, the shaft 213 protrudes downward beyond the lower rotor holder 214b.

The blade support portion 42c preferably includes a plurality of motor support pedestals 421a1, a blade support seat 4222c, a blade support position deciding section 61 and a blade support protrusion section 62. The blade support portion 42c preferably has a substantially cup-like shape opened upward. The motor support pedestals 421a1 protrude axially upward toward the attachment portions 2110b. The motor support pedestals 421a1 are equally spaced apart in the circumferential direction about the center axis. The motor support pedestals 421a1 have screw holes 421a2 extending downward from the upper surface thereof. Fasteners, such as, for example, screws 32 are inserted into the attachment portions 2110b and the thread holes 421a2 from above and are tightened to the thread holes 421a2. As a result, the blade support portion 42c is fixed to the rotor holder 210. With this configuration, the screws 32 are positioned inside the ceiling fan 12 and, therefore, do not mar or affect the outward appearance of the ceiling fan 12.

The blade support seat 4222c is positioned radially outward of the motor support pedestals 421a1 and preferably is ring-shaped. The blades 44 are preferably fixed to the blade support seat 4222c by fasteners, such as, for example, screws 31. The method of fixing the blades 44 to the blade support seat 4222c is not limited to screw-fixing but may be alternatively be, for example, welding, caulking, etc.

The blade support position deciding section 61 lies radially inward of the motor support pedestals 421a1 and extends axially upward. The blade support position deciding section 61 is preferably arranged into a cylindrical or substantially cylindrical shape about the center axis J1. The blade support position deciding section 61 covers a portion of the outer circumferential surface of the lower rotor holder member 241. Preferably, the blade support position deciding section 61 covers the outer circumferential surface of the small inner diameter portion 2144. With this configuration, it is possible to increase the coaxial accuracy of the blade support portion 42c and the motor 1. This makes it possible to prevent reduction of the efficiency otherwise caused by the misalignment of the rotation center of the blades 44 and the rotation center of the motor 1. While the blade support position deciding section 61 is provided in a cylindrical or substantially cylindrical shape in the present preferred embodiment, the present invention is not limited thereto. The blade support position deciding section 61 may be, e.g., a plurality of arc-shaped protrusions or a plurality of circular columns.

The blade support portion 42 preferably includes a substantially ring-shaped blade support protrusion section 62 extending axially upward between the blade support portion 42c and the blade support seat 4222c. The blade support protrusion section 62 is radially opposed to an upper cover protrusion portion 52 to be described later.

The upper cover 5c has a substantially cup-like shape opened downward. The upper cover 5c is fixed to the shaft 213. The upper cover 5c preferably includes an upper cover body portion 51 covering the upper portion of the motor 1, an upper cover protrusion portion 52, and an upper cover outer portion 53. The upper cover protrusion portion 52 extends axially downward from the upper cover body portion 51 and has a substantially annular shape. The upper cover protrusion portion 52 is positioned radially inward of the blade support protrusion section 62 and is radially opposed to the blade support protrusion section 62. As a result, the route leading from the outside to the circuit board 224 grows longer, which makes it possible to prevent or substantially prevent infiltration of particles (e.g., dust). The upper cover protrusion portion 52 may be included in the upper cover body portion 51 or the upper cover outer portion 53. In other words, the upper cover protrusion portion 52 may extend axially downward from a position where the upper cover protrusion portion 52 radially overlaps with the upper cover body portion 51 or may extend axially downward from a position where the upper cover protrusion portion 52 radially overlaps with the upper cover outer portion 53. In other words, the upper cover 5c preferably includes the upper cover body portion 51 covering the upper portion of the motor 1 and the upper cover outer portion 53 extending radially outward from the upper cover body portion 51. Further, the upper cover body portion 51 or the upper cover outer portion 53 includes the upper cover protrusion portion 52 extending axially downward and the upper cover outer portion 53 extends radially outward beyond the inner circumferential surface of the blade support portion 42c.

The upper cover outer portion 53 extends radially outward from the upper cover body portion 51. The outer diameter of the upper cover outer portion 53 is preferably larger than the outer diameter of the blade support portion 42c. At least the upper cover outer portion 53 extends radially outward beyond the inner circumferential surface of the blade support portion 42c. The upper cover outer portion 53 and the blade support seat 4222c are axially opposed to each other. As a result, it is possible to prevent or substantially prevent particles (e.g., dust) from infiltrating onto the circuit board 224.

The upper cover outer portion 53 preferably includes a screw passage portion 54. The screw passage portion 54 is a circular or substantially circular through-hole or a cutout. The diameter of the screw passage portion 54 is equal to or larger than the diameter of the screw 31. The screw passage portion 54 is positioned above the motor support pedestals 4222c. The radial position of the screw passage portion 54 and the radial position of the blade support seat 4222c overlap with each other. Therefore, when attaching and detaching the blades 44, a screw driver, for example, can be axially inserted through the screw passage portion 54. As a result, it becomes possible to tighten or loosen the screw 31 and to perform such a work without having to remove the upper cover 5c.

The upper end of the screw passage portion 54 is preferably positioned lower than the upper end of the blade support protrusion section 62. This makes it possible to prevent or substantially prevent the infiltration of particles (e.g., dust).

While certain preferred embodiments of the present invention have been described above, the present invention is not limited to the foregoing preferred embodiments.

In the foregoing preferred embodiments, the upper flange 2111 and the lower flange 2141 protrude radially outward from the upper rotor holder member 211 and the lower rotor holder member 214. Alternatively, only one of the upper flange 2111 and the lower flange 2141 may be provided if the upper rotor holder member 211 and the lower rotor holder member 214 are fixed to each other. In other words, the attachment portions 2110b may be arranged in only one of the upper flange 2111 and the lower flange 2141.

In the second preferred embodiment, it is not essential to provide the upper flange 2111 and the lower flange 2141.

In the third and fourth preferred embodiments, the blade support seat 4222a or 4222c need not necessarily have the axially-extending through-hole. For example, the blade support seat 4222a or 4222c may instead include a female thread hole.

The circuit board and the board case may be positioned below the lower rotor holder. In this case, the board case covers the circuit board from below. The board case is fixed to the stationary unit and is preferably fixed to the shaft by a screw.

In the fourth preferred embodiment, the upper cover protrusion portion may be positioned radially outward of the blade support protrusion section. In this case, the upper cover protrusion portion may axially extend from the upper cover outer portion.

In the third and fourth preferred embodiments, the upper cover may be fixed to the board case.

The rotor may be a rotor core defined by laminating magnetic plates one above another. In this case, a power supply arranged to drive the motor is an AC power supply. In this case, the motor is preferably an induction motor.

The configurations of the preferred embodiments and the modified examples described above may be combined unless a conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A ceiling fan motor, comprising:
a stationary unit;
a rotary unit; and
a bearing unit; wherein
the stationary unit includes:
a shaft arranged along a center axis extending in an up-down direction; and
an armature directly or indirectly fixed to the shaft;
the rotary unit includes:
a rotor holder arranged to cover the armature from above and below, the rotor holder including an upper rotor holder member and a lower rotor holder member; and
a rotor annularly arranged on an inner circumferential surface of the rotor holder in a radially opposing relationship with the armature;
the bearing unit rotatably supports the rotor holder with respect to the armature, and includes:
an upper bearing member arranged between the shaft and the rotor holder at an axial upper side of the armature, and a lower bearing member arranged between the shaft and the rotor holder at an axial lower side of the armature; and
the rotor holder includes an attachment portion arranged radially outward of the bearing unit so that an impeller of a ceiling fan can be attached to the attachment portion.

2. The motor of claim 1, wherein the rotor holder includes a flange protruding radially outward, the attachment portion being arranged in the flange.

3. The motor of claim 2, wherein the flange includes an upper flange extending radially outward from a lower end of the upper rotor holder member and a lower flange extending radially outward from an upper end of the lower rotor holder member, the upper flange and the lower flange making contact with each other in an axial direction.

4. The motor of claim 2, wherein the attachment portion includes a through-hole axially extending through the flange.

5. The motor of claim 2, wherein the flange includes a plurality of ribs protruding toward at least one of an axial upper side and an axial lower side.

6. The motor of claim 2, wherein the rotor is fixed to an inner circumferential surface of the upper rotor holder member, the lower rotor holder member including a lower region portion positioned axially below the rotor such that a gap is defined between the lower region portion and the rotor.

7. The motor of claim 6, wherein the lower region portion is positioned lower than an upper surface of the lower flange.

8. The motor of claim 2, wherein the stationary unit further includes:
a board case fixed to the shaft; and
a circuit board fixed to the board case and configured to perform drive control of the motor; wherein
each of the board case and the circuit board includes a small-diameter portion positioned radially inward of the attachment portion when seen in the axial direction and a large-diameter portion positioned radially outward of the attachment portion when seen in the axial direction.

9. The motor of claim 8, wherein the shaft includes a guide groove or a guide hole arranged to guide a conductive wire extending from the armature to an axial upper side of the rotor holder, the conductive wire being electrically connected to the circuit board near the small-diameter portion.

10. A ceiling fan, comprising:
the motor described in claim 1;
a blade support portion fixed to the rotor holder, the blade support portion having a substantially cup-shaped configuration which is opened axially upward; and
an impeller including a plurality of blades extending radially outward from the blade support portion.

11. The ceiling fan of claim 10, wherein the blade support portion includes a plurality of motor support pedestals protruding axially upward toward the attachment portions, the attachment portions and the motor support pedestals being fixed to each other.

12. The ceiling fan of claim 10, further comprising:
an upper cover fixed to the stationary unit; wherein
the upper cover includes:
an upper cover body portion arranged to cover an upper portion of the motor; and
an upper cover outer portion extending radially outward from the upper cover body portion;
the upper cover body portion or the upper cover outer portion includes an upper cover protrusion portion extending axially downward; and
the upper cover outer portion is extended radially outward beyond an inner circumferential surface of the blade support portion.

13. The ceiling fan of claim 12, wherein the blade support portion includes a substantially ring-shaped blade support protrusion section extending radially upward, the upper cover protrusion portion and the blade support protrusion section being radially opposed to each other.

14. The ceiling fan of claim 13, wherein the blade support portion includes a ring-shaped blade support seat defined in a radial outer circumference thereof;
the plurality of blades is fixed to the blade support seat by screws;
the upper cover outer portion is extended radially outward beyond the positions of the screw when seen in a plan view;
the upper cover outer portion includes a screw passage portion of a substantially circular through-hole or cutout shape, the screw passage portion being positioned above the motor support pedestals; and
a diameter of the screw passage portion is equal to or larger than a diameter of the screw, a radial position of the screw passage portion and a radial position of the blade support seat overlapping with each other.

15. The ceiling fan of claim 14, wherein the upper end of the screw passage portion is positioned lower than the upper end of the blade support protrusion section.

16. The ceiling fan of claim 10, wherein the blade support portion includes a cylindrical or substantially cylindrical blade positioning section coaxial with the center axis and extending axially upward, the blade positioning section making contact with the outer circumferential surface of the lower rotor holder.
